(19) United States
(12) Patent Application Publication
(10) Pub. No.: US 2013/0114273 A1
(43) Pub. Date: May 9, 2013

(54) RADIOFREQUENCY SCREENING ASSEMBLY FOR AN ELECTRODELESS PLASMA LIGHTING DEVICE AND ELECTRODELESS PLASMA LIGHTING DEVICE AND PRODUCTION METHOD THEREFOR

(71) Applicant: Boris Lutterbach, Muhlheim (DE)

(72) Inventor: Boris Lutterbach, Muhlheim (DE)

(21) Appl. No.: 13/658,902

(22) Filed: Oct. 24, 2012

Related U.S. Application Data
(60) Provisional application No. 61/551,468, filed on Oct. 26, 2011.

(30) Foreign Application Priority Data
Oct. 24, 2011 (DE) 10 2011 054 759.2

(51) Int. Cl. F21V 15/01; F21V 17/10

(52) U.S. Cl. CPC F21V 15/01; F21V 17/10
USPC 362/368; 29/428

(57) ABSTRACT

The invention relates to a radiofrequency (rf) screening assembly for an electrodeless plasma lighting device having a illuminant member (16) which is excited for illumination by means of a radiofrequency (rf), said assembly comprising a screening (shielding) cage (2), which is made of an electrically conductive material or at least has a surface of an electrically conductive material and has a mesh portion (20, 21) for accommodating the illuminant member (16) therein, and a holding means (50, 6) for holding the screening cage (2) at a housing portion (11) of said plasma lighting device. According to the invention a circumferential recess (54) is provided for accommodating an rf-sealing member (9) for sealing against the radiofrequency in order to seal the screening cage (2) against the leaking of the radiofrequency radiation. Furthermore a method for producing such a radiofrequency (rf) screening assembly is disclosed.

### CROSS-REFERENCE TO RELATED APPLICATIONS

The present application claims priority under 35 U.S.C. §119(a) to German Application No. DE 10 2011 054 759.2 filed on 24 Oct. 2011, and claims benefit under 35 U.S.C. §119(e) to U.S. Provisional Application No. 61/551,468 filed on 26 Oct. 2011, the entirety of both of which is incorporated herein by reference.

### FIELD OF INVENTION

The present invention relates in general to electrodeless plasma lighting devices and in particular to a radiofrequency screening or shielding assembly and a production method therefor.

### BACKGROUND OF THE INVENTION

Such plasma lighting devices, also referred to as a microwave lamp, comprise an illuminant member, which is formed as quartz glass body filled with a noble gas at low pressure, said quartz glass body being coated with a metal halide. The microwave irradiation generates plasma inside the illuminant member, in which the noble gas filling is ionized. The plasma causes the metal halide to be evaporated. Noble gas plasma and metal halide vapor together emit light over a broad spectral range. This spectrum can be changed by doping the coating. Such lamps are characterized in particular by a high light output and lamp life. Conventional plasma lighting devices have a relatively complex structure, which is reflected in higher costs. Important in such an illumination apparatus is that a leakage of the radio frequency radiation used for exciting the illuminant member into the environment is prevented as far as possible.

For this purpose the illuminant member itself is usually arranged in a mesh cage, which acts as a Faraday cage and is substantially impermeable for the exciting radio frequency radiation, but can pass light to a sufficient extent.

Such as a mesh cage serving as a screening cage is disclosed, for example in U.S. Pat. No. 7,902,766. A stem on which the illuminant member is arranged extends via an uncoupling opening of a microwave waveguide, wherein the illuminant body itself is disposed within the screening cage, which is arranged within a reflector reflecting the light emitted by the illuminant member. The screening cage presses the reflector against a cylindrical sleeve on a housing portion of the lighting device, in order to prevent leakage of the radio-frequency radiation. By means of this arrangement it is, however, not easily possible to provide a complete shielding or screening of the rf-frequency. This arrangement is particularly susceptible to mechanical vibrations in continuous operation, which can lead to leakage of radio-frequency radiation.

Another radio frequency screening assembly is disclosed in U.S. Pat. No. 5,811,936. The screening cage is formed by a cylindrical side member accommodating the illuminant body and by a circular top cover which are connected together. While the front end of the cylindrical side member is formed as a screening mesh, the lower end is formed without any apertures, wherein at its lower end a plurality of fingers are formed by a plurality of longitudinal slots disposed at equal angular intervals. These fingers are folded or bent by 90° and then supported on or mounted to a housing portion of the microwave lamp. On the housing portion itself, a cylindrical holding sleeve is formed, against which the cylindrical side member is pressed by means of a ring-shaped clamp. With this arrangement, however, a leakage of radio frequency radiation cannot be reliably prevented.

For manufacturing the cylindrical side member a rectangular metal sheet is used. A mesh pattern is formed, for example by means of an etching process, in the metal sheet. The metal sheet including the mesh pattern is then bent so that peripheral webs, which do not have apertures or bores, overlap with each other. Subsequently, a spot welding process along the peripheral webs is performed. This sometimes results in an accidental opening of the screening cage. Radio-frequency radiation could also leak via the open spaces between the welding spots. Also, the cylindrical side member and the upper cover are usually connected with each other by means of spot welding. Radio-frequency radiation could also leak via the open spaces between the individual welding spots.

U.S. Pat. No. 5,142,101 discloses a ribbon-like rf-gasket having a flexible core and a method for manufacturing the same.

Further ribbon-like rf-sealing members are disclosed in DE 2328951 C3, U.S. Pat. No. 4,820,885 and U.S. Pat. No. 6,331,349. Further details of the configuration of rf-screening assemblies including such rf-sealing members are, however, not disclosed.

### SUMMARY OF INVENTION

It is an object of the present invention to provide an enhanced rf-screening or shielding assembly for electrodeless plasma lighting devices. A further object of the present invention is to provide an enhanced rf-screening or shielding assembly for electrodeless plasma lighting devices which has a simple configuration and can be manufactured at reduced costs.

According to a further aspect of the present invention an electrodeless plasma lighting device including such an rf-screening or shielding assembly is to be provided.

According to a further aspect of the present invention a method for manufacturing such an rf-screening or shielding assembly is to be provided.

According to the present invention the above problems are solved by a radiofrequency screening or shielding assembly according to claim 1, by an electrodeless plasma lighting device according to claim 17 and by a method for producing a radiofrequency screening or shielding assembly according to claim 18. Further advantageous embodiments are the subject-matter of the dependent claims.

A radiofrequency (rf) screening assembly according to the present invention for an electrodeless plasma lighting device having a illuminant member, which is excited for illumination by means of a radiofrequency (rf), comprises a screening or shielding cage made of an electrically conductive material or having at least a surface of an electrically conductive material, e.g. of a metal sheet or a metalized plastic sheet, and having a mesh portion for accommodating the illuminant member therein, and a holding means for holding the screening cage at a housing portion of said plasma lighting device, for example on an outer surface of the microwave guide. The mesh portion comprises a plurality of apertures or openings, preferably disposed in a regular pattern, and passes light (is transmissive to light) to a sufficient extent and acts as a Faraday cage for reliably screening rf-radiation. In such a screening assembly according to the invention a circumferential recess is provided, which accommodates an rf-sealing member for sealing against the radiofrequency. By means of the rf-sealing member leakages can be sealed even more reliably, in particular in the transition area between the screening cage and the housing portion. The rf-sealing member preferably has a certain elasticity and so that a pressure can be applied in a reliable and controllable manner, e.g. by means of a pressing ring to thereby accomplish a reliable rf-screening effect.

According to a further embodiment, the rf-sealing member is a flexible ribbon or belt, into which a metallic member is integrated, but may also be a metal ribbon wrapped around a flexible ribbon or belt (e.g. of plastics or metal), or a flexible fabric of a metallic material or a deformable metallic material. For this purpose the same or different kinds of metals can be used as for the housing portion and/or the screening cage. Preferably, the rf-sealing member is circumferential, e.g. corresponding to an associated receiving profile at the housing portion or of a holding means for the screening cage or also on the bottom side of the screening cage, where the rf-sealing member is accommodated. Preferably a conductive coupling between the screening cage and the housing portion is implemented for this purpose, in particular via the preferably conductive rf-sealing member.

Basically, the aforesaid recess may be formed at any suitable location for accommodating the rf-sealing member therein. Preferably, the holding means is formed as a circumferential ring, which is connected with the housing portion. According to a further embodiment the recess is formed on a bottom surface of the circumferential ring facing the top surface of the housing portion or in a top surface of the housing portion. The dimensions of the recess can be set such that that in a relaxed state, i.e. in the absence of an external pressure, a maximum height or a maximum diameter of the rf-sealing member is slightly greater than the depth of the aforementioned recess. Thus the sealing member is compressed only if a predetermined minimum force or a predetermined minimum pressure is applied to the screening assembly to thereby accomplish an rf-screening effect.

According to a further embodiment the circumferential ring is pressed against the housing portion by a pressing ring. In this way forces can be transferred in a homogeneous and controllable manner onto the circumferential ring. Preferably the pressing ring also serves for clamping the screening cage. For this purpose, according to the invention an edge portion, which is folded under an angle from the lower rim of the screening cage, is clamped between the pressing ring and the circumferential ring. The pressing ring (compression ring) enables in particular an advantageously simple assembly, since initially the holding means together with the rf-sealing member can be mounted on the housing portion, then the screening case can be put flat on a top surface of the holding means and then the pressing ring can be pushed and subjected to a pressure, for example by uniformly tightening of fastening screws or activating a clamping device, for example a clamping ring.

According to a further embodiment the circumferential ring is formed as a flange of a cylindrical sleeve portion which supports a lower edge portion of the screening cage and projects perpendicularly from the housing portion. The flange has a sufficient area to receive therein the recess and to support a lower edge of the screening cage. The cylindrical sleeve portion may have an outer diameter which corresponds to the inner diameter of the cylindrical screening cage, so that the sleeve portion at the same time can serve as a contact surface and supporting surface.

According to a further embodiment, the lower edge portion of the screening cage is formed closed, i.e. without apertures, over the axial length of the cylindrical sleeve portion or is substantially formed without apertures and is formed integrally with the mesh portion of the screening cage. This can be accomplished, for example, by etching of the mesh portion from a metal sheet. The integral configuration improves the effect of the screening cage as a Faraday cage. Since the lower edge portion of the screening cage does not have any openings or apertures, in particular is formed without such a mesh surface, this edge portion is more stable, so that the positioning of the screening cage can be more reliable, thus preventing weak points in the rf-shielding even more reliably.

According to a further embodiment the mesh portion is formed by a circumferential side member and a cover member connected with it, for example embodied as a round screening cover formed of a mesh-like grid surface. This two-part design enables highly reliable specification and compliance with the geometry of the screening assembly.

According to a further embodiment, the side member and a lower edge portion of the screening cage are integrally made of a metal sheet. The side member has in this case a mesh surface, the longitudinal sides of which are formed in the axial direction of the screening cage by two peripheral webs, which have no apertures and which are mutually bonded, in particular by means of laser soldering or laser welding, to form the circumferential side portion. While according to the prior art, the peripheral webs overlap with each other and are then spot welded, according to the present invention the peripheral webs are disposed face-to-face and joined together in a tool and fixed to form the cylindrical screening cage. At the abutting edges preferably a complete continuous weld is formed, for example by laser soldering or laser welding.

According to a further embodiment, also a top edge of the side member is formed as a peripheral web having no apertures. This top edge is connected with a peripheral edge of the cover member so as to jointly form the cylindrical screening cage. Such peripheral webs having no apertures enable precisely defined joining surfaces that enable a reliable rf-tight connection between the two members.

According to a further embodiment, the cover member also comprises a central mesh surface, which is sufficiently rf-tight but transmits the light emitted by the illuminant member to a sufficient extent.

Here, the central mesh surface is preferably surrounded by a circumferential peripheral web, which precisely defines and stabilizes the shape of the central mesh surface and is connected with the side member via the cover member.

According to a further embodiment, connecting webs are formed on the circumferential peripheral web of the cover member, which project in radial direction from the latter and merge into connecting lugs, which are connected to the peripheral web on the upper edge of the side member.

According to a further embodiment, a plurality of such radial connecting webs together support a connecting plate or connecting flap, said connecting flaps being respectively angled away from the connecting webs. The connecting flaps or connecting lugs are preferably connected to the peripheral web having no apertures at the top edge of the cylindrical side member, which further enhances the rf-screening effect.

According to a further embodiment, an electrodeless plasma lighting device is provided comprising such a radio-frequency screening assembly as set forth above.

According to a further embodiment, further a method for manufacturing a radio-frequency screening assembly as set forth above is provided.

### OVERVIEW ON DRAWINGS

Hereinafter the invention will be described in exemplary manner and with reference to the appended drawings, from which further advantages, features and problems to be solved may be derived, wherein.

FIG. 1a, 1b show the components of a screening cage according to a first embodiment of the present invention;

FIG. 2 shows in a side view a screening cage according to a further embodiment of the present invention;

FIGS. 3 and 4 show the details A and B of FIG. 2;

FIGS. 5a and 5b show the bottom rim of the side member of FIG. 2 in an enlarged partial sectional view;

FIG. 6 shows a cover member to be connected with the side member of FIG. 2;

FIG. 7 shows the detail C of FIG. 6;

FIG. 8 is another partial enlarged view of FIG. 7;

FIG. 9 shows in a largely enlarged view the connecting area between the side member and the cover member;

FIG. 10 shows in a largely enlarged view the connection between the axial margial webs of the side member of FIG. 2;

FIG. 11a and 11b show a cylindrical sleeved serving as a holding means;

FIG. 12 shows in a schematic section view an rf-screening assembly according to the present invention.

Throughout the drawings the same reference number relate to the same or substantially equivalent elements or groups of elements.

### DETAILED DESCRIPTION OF PREFERRED EMBODIMENTS OF THE PRESENT INVENTION

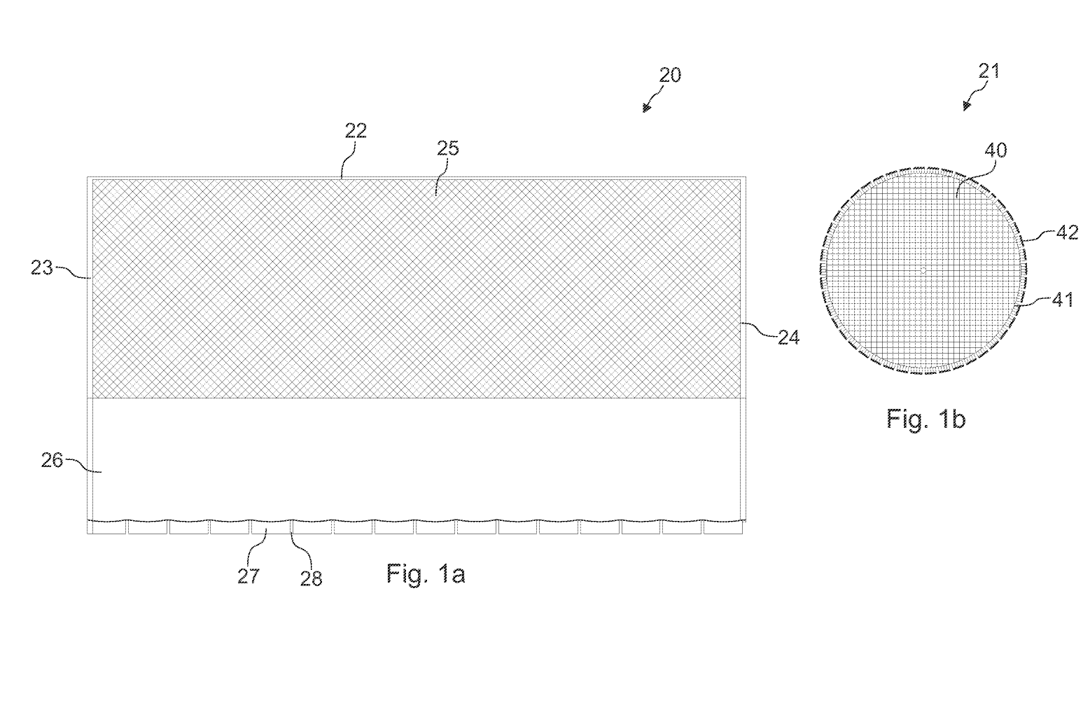

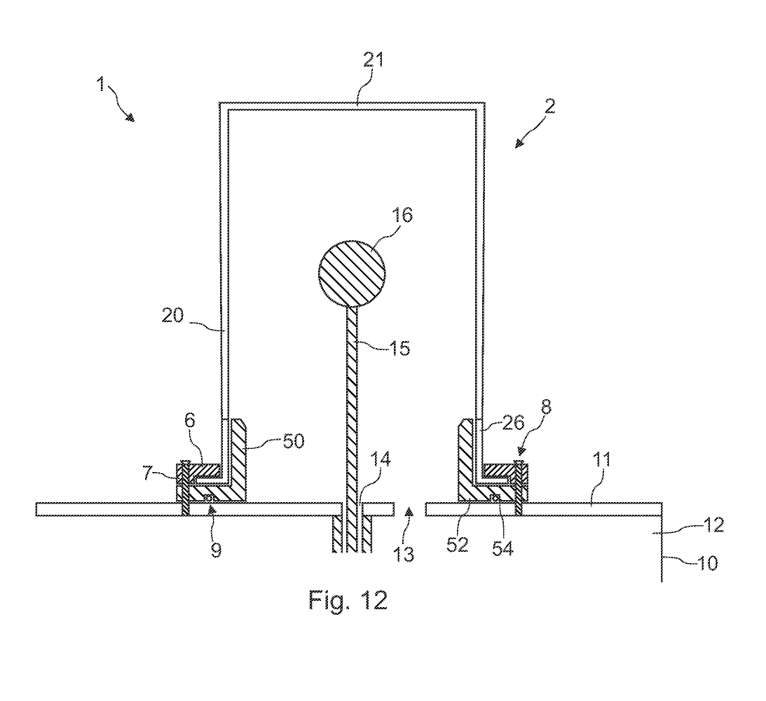

FIGS. 1a and 1b show a rectangular side member 20 and circular cover 21, which together form a cylindrical screening cage of an rf-screening assembly according to the present invention, as shown in FIG. 12. The side member 20 comprises a mesh surface 25 along the upper edge thereof, which comprises a plurality of apertures, preferably formed in a regular pattern, for example in the manner of a metal screen or metal grid. The mesh surface 25 is surrounded by an upper peripheral web 22 and two side webs 23 and 24, which extend in the axial direction of the cylindrical screening cage. The peripheral webs 23, 24 are formed without apertures, i.e. without openings or bores. Along the lower edge a contact surface 26 extends, which is formed without apertures and preferably has the same height as the associated cylinder 50 of a holding member or retaining member (see FIG. 12). In the embodiment according to FIG. 1a the contact surface 26 is formed without apertures. Along the lower edge and at equal angular intervals from one another, a plurality of longitudinal slots 28 are provided which divide the lower edge into a plurality of rectangular-shaped fingers 27, which are bent perpendicularly to form the screening assembly according to FIG. 12 and then abut on the upper side of the holding member.

As shown in FIG. 1b, the cover member 21 comprises a central mesh surface 40, which is surrounded by a peripheral web 41 having no apertures, from which radial connecting webs protrude (see FIG. 8, reference numeral 44), which merge into associated connecting lugs or connecting flaps 46 (FIG. 9).

Side member 20 and cover member 21 are preferably formed from a metal sheet, for example by etching a thin metal sheet. By means of an etching process, the structures of the mesh surface but also the connecting webs and connecting lugs may be formed precisely. Basically, the side member 20 and the cover member 21 can also be formed in a corresponding manner from a plastic material, whose surface is coated with an electrically conductive material, such as metal, so that it can serve as a Faraday cage.

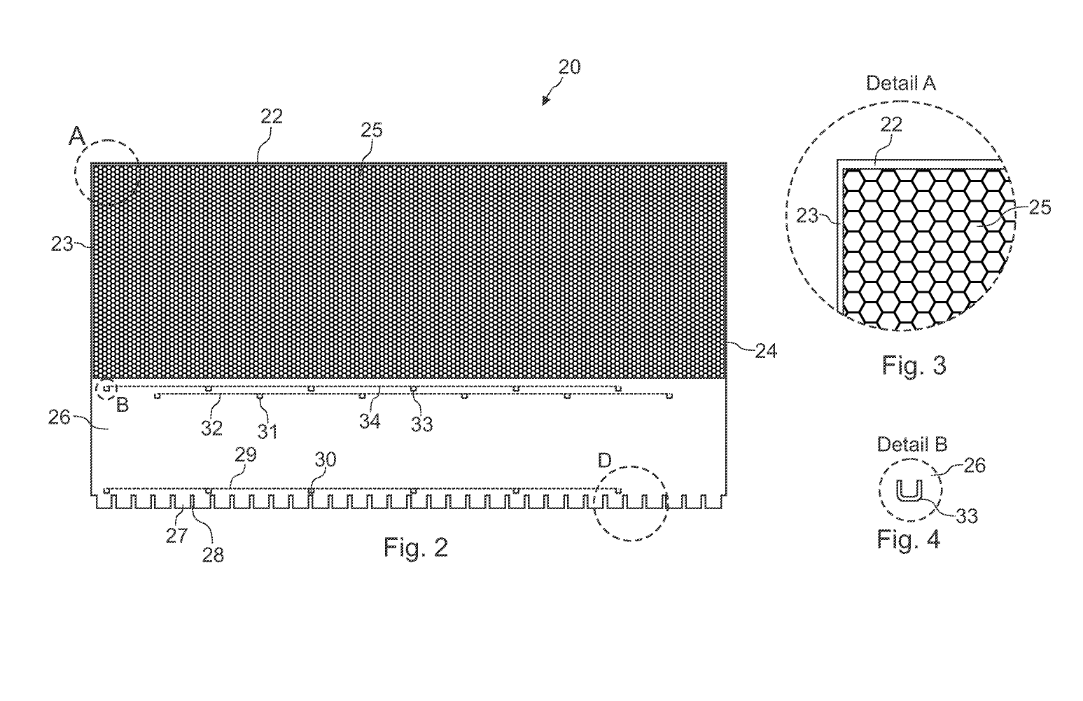

FIG. 2 shows a further embodiment of a side member 20 according to the present invention, wherein, in addition a plurality of U-slots 30, 31 and 33 are formed along the virtual connecting lines 29, 32 and 34, which are disposed at equal intervals to each other. These U-slots 30, 31 and 33 are yet formed in the region of the contact surface 26, which is located directly opposite in the assembled state of the screening assembly, and thus are still in the region of the cylindrical tube member 50 (see FIG. 12), so that no rf-radiation may leak via these U-slots 30, 31 and 33. These U-slots 30, 31 and 33 preferably serve to accomplish a voltage compensation effect, but also enable a certain elasticity of the side member 20 and of the contact surface 26 and thus overall enable a more uniform contact of the contact surface 26 on the cylindrical tube member 50 of the holding member.

The magnified partial view according to FIG. 4 shows a U-slot 33, which is formed on the virtual connecting line 34. Thus a lug is formed within the U-slot 33, so that the side member 26 has a certain degree of elasticity.

The magnified partial view according to FIG. 3 shows the upper left corner area A, which is formed by the peripheral webs 22 and 23. The apertures of the mesh surface 25 in this embodiment are honeycomb-shaped.

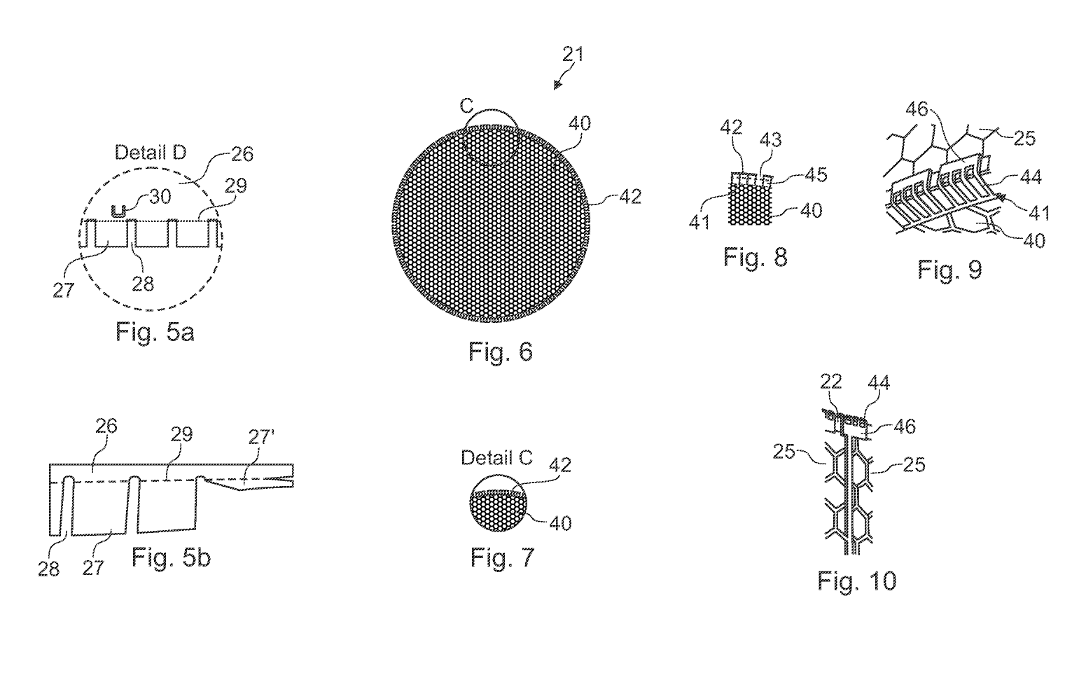

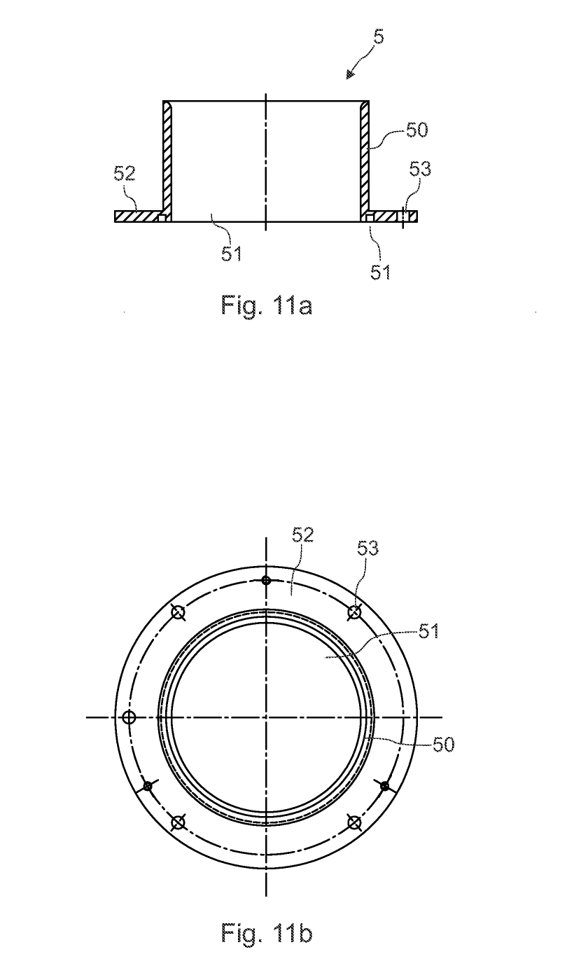

The magnified partial view according to FIG. 5a shows a U-slot 30 at the lower edge of contact surface 26. It is also shown that the front ends of the axial slots 28 extend up to the virtual connecting line 29, so that the lengths of the fingers 17 thus formed are the same. FIG. 5b shows a finger (reference numeral 27′) already folded perpendicularly and indicates the manner in which all the fingers 27 may be angled or folded along the virtual connecting line or folding line 29.

FIG. 6 shows a cover member 21 according to a further embodiment, wherein the apertures of the central mesh surface 40 are formed honeycomb-shaped. FIG. 7 shows a partial enlargement C and indicates that a plurality of fingers 42 protrude in radial direction from the central mesh surface 40 at equal angular intervals, which serve for connecting or joining the cover member 21 with the side member 20, as explained in more detail below.

FIG. 8 shows a further magnified partial view of the portion according to FIG. 7. It is apparent that the central mesh surface 40 is surrounded by a peripheral web 41, which has no apertures (in the embodiment following a circular line), from which in turn, a plurality of radial connecting webs 44 protrude in radial direction having connecting lugs 42 formed at a front end thereof. In particular, in the embodiment of FIG. 8, three radial connecting webs 44 support a common connecting lug 42. Mutually adjacent connecting lugs 42 are separated from each other by a radial recess 43, wherein the recesses are formed at equal angular intervals to each other along the circumference of the peripheral web 41.

The dashed line in FIG. 8 indicates a folding line along which the connecting webs 44 with the connecting lugs 42 supported thereon are angled or folded, as shown in FIG. 9. Due to this bending, there is an overlap between the connecting lugs 46 and the peripheral web 22 at the upper end of the side member 20. The substantially full-surface contact of the connecting lugs 46 with the upper peripheral web 22 may be used for a variety of bonding techniques, for example by soldering, in particular laser soldering or spot welding.

FIG. 10 shows, how the two axial peripheral webs 23, 24 of the side member 20 are connected or joined with each other. Contrary to the prior art, where the peripheral webs are arranged in an overlapping manner and are then welded, according to the present invention the two peripheral webs 23, 24 are arranged face-to-face and then temporarily fixed so that they cannot slip during the subsequent welding process, and then they are joined by soldering or welding, in particular by laser soldering or laser welding.

Thus, for manufacturing a screening cage the procedure is as follows:

Firstly, the side member 20 and the cover member 21 are formed as described above and shown in FIGS. 1 and 2. Subsequently, the side member 20 (see FIG. 2) is bent to form a hollow cylinder, and finally the two axial peripheral webs 23, 24 come into contact with each other. Preferably, these do not overlap with each other but are disposed face-to-face to each other and their position is temporarily fixed by means of a tool or a holding blank. Subsequently, the two peripheral webs 23, 24 are joined with each other, preferably by laser soldering. The two peripheral webs 23, 24 can be joined with each other over their entire length and not only at individual soldering points.

Then the radial connecting webs 44 (see FIG. 9) supporting the connecting lugs or connecting flaps 46 are bent or folded along a folding line, as described above with reference to FIG. 8. Such a cover member is inserted from the inside into the hollow cylinder of the side member 20, until finally the connecting lugs 46 overlap with the upper peripheral web 22. After temporary fixing of the position of the side member 20 and of the cover member 21 relative to each other, these two members are joined with each other, in particular by means of laser soldering. Again, the joining is formed basically continuously and without apertures, so that an accidental opening of the screening cage and an accidental leakage of rf-radiation is reliably prevented.

FIG. 12 shows an rf-screening assembly 1 according to the present invention, which is disposed on a cover 11 of a housing 10 of a plasma lighting device not further illustrated in detail. The cover 11 may form the top of a hollow rf-waveguide 12, wherein its rf-radiation is coupled via the coupling-out opening 13 into the cavity formed by the screening cage 2 in which the illuminant ball 16 is supported by the shaft 15. The screening cage 2 with its right-angled fingers 27 is supported on the upper side of the flange 52, which merges into a cylindrical tube member 50, which is in a full-surface contact to the abutment surface 26, which has no apertures. The height of the cylindrical tube member 50 corresponds to the height of the contact surface 26. In the bottom side of the flange 52 a circumferential recess or groove 54 is formed in which an rf-sealing member 9 is accommodated, which is preferably a flexible ribbon or belt, in which a metallic material is integrated, but which may also be a metal ribbon, which is wrapped around a flexible ribbon, or a flexible fabric of a metallic material or a deformable metallic material.

According to FIG. 12, the fingers 27 of the screening cage 2 are embraced by a pressing ring 6, the circumferential projection 7 of which rests directly on the upper edge of the flange 52. The pressing ring 6 is pulled toward the cover 11 by a plurality of screws 8 and thus presses the entire assembly uniformly against the housing 10 of the plasma lighting device not further illustrated in detail. Herein, the rf-sealing member 9 may be compressed slightly in the associated recess 54 on the bottom surface of the flange 52. The rf-sealing member 9 provides for an effective sealing between the screening cage 2 and the housing 10 and also between the screening cage 2 and the cylindrical tube member 50, which serves to position and fix the position of the screening cage 2.

### LIST OF REFERENCE NUMERALS

1 rf-screening assembly
2 screening (shielding) cage
5 holding member
6 pressing ring
7 circumferential protrusion
8 screw
9 rf-sealing
10 housing
11 cover
12 rf waveguide
13 coupling opening
14 bore
15 neck
16 illuminant ball
20 side member
21 cover member
22 upper peripheral web
23 side web
24 side web
25 mesh portion
26 abutment portion or face
27,27′ finger
28 recess
29 folding line
30 U-slot
31 U-slot
32 virtual connecting line
33 U-slot
34 virtual connecting line
40 mesh portion
41 peripheral web
42 finger
43 clearance
44 radial connecting web
45 opening
46 connecting lugs
50 tubular member/cylinder
51 central opening
52 flange
53 bore
54 annular groove

1. A radiofrequency (rf) screening assembly for an electrodeless plasma lighting device having an illuminant member which is excited for illumination by means of a radiofrequency (rf), said assembly comprising:
a screening or shielding cage having a mesh portion for accommodating the illuminant member therein; and
a holding means for holding or retaining the screening cage at a housing portion of said plasma lighting device; wherein
said screening or shielding cage is made of an electrically conductive material or at least has a surface of an electrically conductive material;
said radiofrequency (rf) screening assembly further comprising
a circumferential recess, which accommodates an rf-sealing member for sealing against the radiofrequency, to thereby seal the screening cage against leakage of radiofrequency radiation; wherein
said holding means is a circumferential ring connected with said housing portion, and
said circumferential ring is pressed against the housing portion by means of a pressing ring.

2. The radiofrequency (rf) screening assembly of claim 1, wherein the rf-sealing member is one of a flexible ribbon into which a metallic material is integrated, a metal ribbon wound around a flexible ribbon, a flexible fabric of a metallic material and a deformable metallic material.

3. The radiofrequency (rf) screening assembly of claim 1, wherein the recess is formed in a bottom side of the circumferential ring or in an upper side of the housing portion.

4. The radiofrequency (rf) screening assembly of claim 3, wherein the circumferential ring is pressed against the housing portion by means of said pressing ring (6) such that an edge or peripheral portion of the screening cage, which is folded or bent from a bottom rim of the screening cage, is clamped between said pressing ring and the circumferential ring.

5. The radiofrequency (rf) screening assembly of claim 3, wherein the circumferential ring is formed as a flange of a cylindrical sleeve portion, which supports a bottom rim portion of the screening cage and protrudes perpendicularly from said housing portion.

6. The radiofrequency (rf) screening assembly of claim 4, wherein the circumferential ring is formed as a flange of a cylindrical sleeve portion, which supports a bottom rim portion of the screening cage and protrudes perpendicularly from said housing portion.

7. The radiofrequency (rf) screening assembly of claim 5, wherein the bottom rim portion of the screening cage is formed substantially closed or substantially without apertures over the axial length of the cylindrical sleeve portion and is formed integral with the mesh portion of the screening cage.

8. The radiofrequency (rf) screening assembly according to claim 1, wherein the mesh portion is formed by a circumferential side member and a cover member, which is connected with said side member.

9. The radiofrequency (rf) screening assembly of claim 8, wherein said side member is a cylindrical member.

10. The radiofrequency (rf) screening assembly according to claim 8, wherein the side member and a bottom rim portion of the screening cage are formed integrally from a metal sheet, wherein the side member comprises a mesh surface having longitudinal sides, which are formed by two peripheral webs in axial direction of the screening cage, said peripheral webs being joined integrally with each other for forming the circumferential side member, said peripheral webs being formed without apertures.

11. The radiofrequency (rf) screening assembly according to claim 10, wherein said peripheral webs are joined by laser soldering.

12. The radiofrequency (rf) screening assembly according to claim 8, wherein an upper rim of the side member is formed as a peripheral web and without apertures, which is connected with a circumferential rim of the cover member for forming said screening cage.

13. The radiofrequency (rf) screening assembly according to claim 8, wherein the cover member comprises a central screening face, which is enclosed by a circumferential peripheral web, said cover member being joined with the side member via said peripheral web.

14. The radiofrequency (rf) screening assembly according to claim 13, wherein connecting webs protrude in radial direction from said peripheral web, said connecting webs passing into connecting lugs, which are connected or joined with the peripheral web at an upper rim of the side member.

15. The radiofrequency (rf) screening assembly according to claim 14, wherein a plurality of connecting webs together support a connecting lug and wherein the connecting lugs are each bent or folded from the connecting webs.

16. The radiofrequency (rf) screening assembly according to claim 14, wherein the cover member is integrally formed from a metal sheet, in particular by an etch process, and is integrally joined with the peripheral web at an upper rim of the side member, in particular by laser soldering.

17. An electrodeless plasma lighting device, comprising an illuminant member or illuminant ball, which is excited by a radiofrequency radiation to emit light, comprising a radiofrequency (rf) screening assembly for sealing against leaking of radiofrequency radiation, said radiofrequency (rf) screening assembly comprising:
a screening or shielding cage having a mesh portion for accommodating the illuminant member therein; and
a holding means for holding or retaining the screening cage at a housing portion of said plasma lighting device; wherein
said screening or shielding cage is made of an electrically conductive material or at least has a surface of an electrically conductive material;
said radiofrequency (rf) screening assembly further comprising
a circumferential recess, which accommodates an rf-sealing member for sealing against the radiofrequency, to thereby seal the screening cage against leakage of radiofrequency radiation; wherein
said holding means is a circumferential ring connected with said housing portion, and
said circumferential ring is pressed against the housing portion by means of a pressing ring.

18. A method for producing a radiofrequency (rf) screening assembly for an electrodeless plasma lighting device, comprising the steps of:
providing a screening or shielding cage, which is made of an electrically conductive material or has at least a surface of an electrically conductive material, said screening or shielding cage having a mesh portion for accommodating therein an illuminant member of the electrodeless plasma lighting device;
providing a holding means for holding the screening cage at a housing portion of the electrodeless plasma lighting device;
forming a circumferential recess;
providing a sealing member for sealing against leaking of the radiofrequency radiation; and
disposing the sealing member within the circumferential recess for sealing the screening cage against leakage of the radiofrequency radiation; wherein
said holding means is a circumferential ring connected with said housing portion;
said method further comprising:
providing a pressing ring; and
pressing said circumferential ring against the housing portion by means of said pressing ring, to thereby seal the screening cage against leaking of radiofrequency radiation.

19. The method as claimed in claim 18, wherein the step of providing the screening cage further comprises:
providing a rectangular side member having a first mesh surface, which is enclosed by peripheral webs, which are free of apertures;
providing a cover member having a second mesh surface, which is enclosed by a peripheral web;
folding the rectangular side member until the peripheral webs are contacting each other face to face and join or connect the peripheral webs; and
inserting the cover member into the cylindrical screening cage and joining or connecting the cover member and the cylindrically bent side member in the region of the peripheral webs for forming a cylindrical screening cage.
